(19) United States
(12) Patent Application Publication
(10) Pub. No.: US 2026/0179650 A1
(43) Pub. Date: Jun. 25, 2026

(54) DISK DEVICE

(71) Applicants: KABUSHIKI KAISHA TOSHIBA, Kawasaki-shi (JP); TOSHIBA ELECTRONIC DEVICES & STORAGE CORPORATION, Kawasaki-shi (JP)

(72) Inventors: Taichi OKANO, Yokohama Kanagawa (JP); Shinra YAMANAKA, Yokohama Kanagawa (JP); Yoshihiro AMEMIYA, Chigasaki Kanagawa (JP); Nobuhiro YAMAMOTO, Yokohama Kanagawa (JP); Hayato YAMAGUCHI, Sagamihara Kanagawa (JP)

(73) Assignees: KABUSHIKI KAISHA TOSHIBA, Kawasaki-shi (JP); TOSHIBA ELECTRONIC DEVICES & STORAGE CORPORATION, Kawasaki-shi (JP)

(21) Appl. No.: 19/363,776

(22) Filed: Oct. 21, 2025

(30) Foreign Application Priority Data
Dec. 24, 2024 (JP) 2024-227324

(51) Int. Cl. G11B 5/48

(52) U.S. Cl. CPC G11B 5/486

(57) ABSTRACT

A disk device according to an embodiment includes a magnetic disk, a magnetic head, a flexible printed circuit board, and an electronic component. The flexible printed circuit board includes a first insulating layer, a first conductive layer on a first face of the first insulating layer, a second conductive layer on a second face of the first insulating layer, a second insulating layer covering the second face and the second conductive layer, and a first adhesive layer bonding the second insulating layer to the second face and the second conductive layer. The first conductive layer includes a first land. The second conductive layer includes a first part with first through holes, the first part overlapping the first land through the first insulating layer. The first adhesive layer adheres to the second face through the first through holes. The electronic component includes a first pin joined to the first land.

### CROSS-REFERENCE TO RELATED APPLICATIONS

This application is based upon and claims the benefit of priority from Japanese Patent Application No. 2024-227324, filed on Dec. 24, 2024; the entire contents of which are incorporated herein by reference.

### FIELD

Embodiments described herein relate generally to a disk device.

### BACKGROUND

A disk device such as a hard disk drive typically includes a flexible printed circuit (FPC) board and electronic components mounted on the FPC. For example, the pins of the electronic components are joined to pads disposed on the FPC.

For example, moment (torque) may occur and cause an electronic component to rotate (twist) on the FPC surface, applying a force to the FPC in the vicinity of the land in a direction along the FPC surface. This force may act on the adhesive joint between the insulating layer and the conductive layer of the FPC, which may result in lowering the reliability of the FPC.

### BRIEF DESCRIPTION OF THE DRAWINGS

FIG. 1 is an exemplary perspective view illustrating an HDD according to the first embodiment in an exploded manner;

FIG. 2 is an exemplary plan view schematically illustrating the FPC of the first embodiment;

FIG. 3 is an exemplary cross-sectional view schematically illustrating part of the HDD of the first embodiment;

FIG. 4 is an exemplary plan view schematically illustrating a second connection part of the FPC of the first embodiment;

FIG. 5 is an exemplary cross-sectional view schematically illustrating the second connection part and the relay connector of the first embodiment taken along line F5-F5 of FIG. 4; and

FIG. 6 is an exemplary cross-sectional view schematically illustrating part of an HDD according to the second embodiment.

### DETAILED DESCRIPTION

According to an embodiment, a disk device includes a magnetic disk, a magnetic head, a flexible printed circuit board, and an electronic component. The magnetic head is configured to read and write information from and to the magnetic disk. The flexible printed circuit board is electrically connected to the magnetic head. The electronic component is mounted on the flexible printed circuit board. The flexible printed circuit board includes a first insulating layer, a first conductive layer disposed on a first face of the first insulating layer, a second conductive layer disposed on a second face of the first insulating layer, the second face being opposite the first face, a second insulating layer covering the second face and the second conductive layer, and a first adhesive layer bonding the second insulating layer to the second face and the second conductive layer. The first conductive layer includes a first land. The second conductive layer includes a first part with a plurality of first through holes, the first part overlapping the first land through the first insulating layer. The first adhesive layer adheres to the second face through the plurality of first through holes. The electronic component includes a first pin joined to the first land.

### First Embodiment

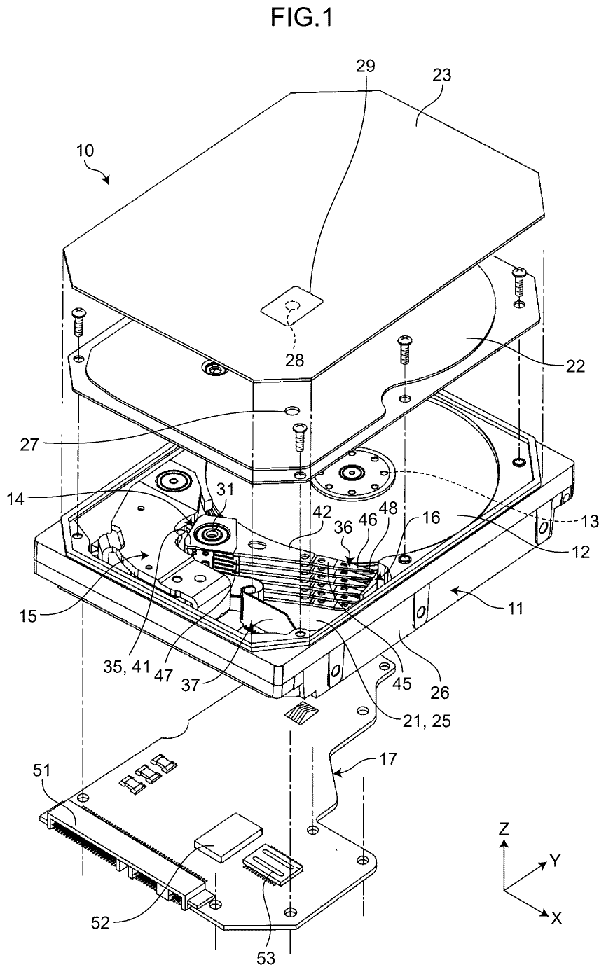

Hereinafter, the first embodiment will be described with reference to FIGS. 1 to 5. Note that, in the present specification, components according to embodiments and descriptions of the components may be described in a plurality of expressions. The components and the description thereof are examples, and are not limited by the expression of the present specification. The components may be identified with names different from those in the present specification. In addition, the components may be described by an expression different from the expression in the present specification.

In the following description, “suppress” is defined as, for example, preventing the occurrence of an event, an action, or an influence, or reducing the degree of the event, the action, or the influence. Furthermore, in the following description, “restrict” is defined as, for example, preventing movement or rotation, or allowing movement or rotation within a predetermined range and preventing movement or rotation beyond the predetermined range.

FIG. 1 is an exemplary exploded perspective view illustrating a hard disk drive (HDD) 10 according to the first embodiment. The HDD 10 is an example of a disk device, and may be referred to as an electronic device, a storage device, an external storage device, or a magnetic disk device. The disk device is not limited to the HDD 10.

As illustrated in the drawings, in the present specification, an X axis, a Y axis, and a Z axis are defined for convenience. The X axis, the Y axis, and the Z axis are orthogonal to each other. The X axis is provided along the width of the HDD 10. The Y axis is provided along the length of the HDD 10. The Z axis is provided along the thickness of the HDD 10.

Furthermore, in the present specification, an X direction, a Y direction, and a Z direction are defined. The X direction is a direction along the X axis and includes a +X direction indicated by an arrow of the X axis and a −X direction which is a direction opposite the arrow of the X axis. The Y direction is a direction along the Y axis, and includes a +Y direction indicated by an arrow of the Y axis and a −Y direction which is a direction opposite the arrow of the Y axis. The Z direction is a direction along the Z axis and includes a +Z direction indicated by an arrow of the Z axis and a −Z direction which is a direction opposite the arrow of the Z axis.

As illustrated in FIG. 1, the HDD 10 includes a housing 11, a plurality of magnetic disks 12, a spindle motor 13, a head stack assembly (HSA) 14, a voice coil motor (VCM) 15, a ramp load mechanism 16, and a printed circuit board (PCB) 17. The magnetic disk 12 may be referred to as a disk, a medium, or a platter.

The housing 11 includes a base 21, an inner cover 22, and an outer cover 23. Note that the housing 11 is not limited to this example. The base 21 has a substantially rectangular parallelepiped shape opened in the +Z direction. The base 21 accommodates the plurality of magnetic disks 12, the spindle motor 13, the HSA 14, the VCM 15, and the ramp load mechanism 16.

The base 21 has a bottom wall 25 and a side wall 26. The bottom wall 25 has a substantially rectangular (quadrangular) plate shape disposed to be substantially orthogonal to the Z direction. The side wall 26 protrudes from the edge of the bottom wall 25 in the substantially +Z direction and has a substantially rectangular frame shape.

The inner cover 22 is attached to the end portion of the side wall 26 in the +Z direction with, for example, a screw to close the base 21. The outer cover 23 covers the inner cover 22 and is attached to the end portion of the side wall 26 in the +Z direction by welding, for example.

The inner cover 22 has a vent 27. Furthermore, the outer cover 23 has a vent 28. After the components are attached to the inside of the base 21 and the inner cover 22 and the outer cover 23 are attached to the base 21, the air inside the housing 11 is discharged from the vents 27 and 28. Furthermore, the housing 11 is filled with a gas different from air.

The gas with which the inside of the housing 11 is filled is, for example, a low density gas having a density lower than that of air, an inert gas having low reactivity, or the like. For example, the inside of the housing 11 is filled with helium. The inside of the housing 11 may be filled with another fluid.

The vent 28 of the outer cover 23 is closed by a seal 29. The seal 29 hermetically seals the vent 28 and restricts leaking of the fluid with which the inside of the housing 11 is filled from the vent 28 to the outside of the housing 11.

The plurality of magnetic disks 12 is disposed substantially parallel to the bottom wall 25. The plurality of magnetic disks 12 is disposed at intervals in the Z direction. The spindle motor 13 supports the plurality of magnetic disks 12. The plurality of magnetic disks 12 is held by the hub of the spindle motor 13 by, for example, a clamp spring. The spindle motor 13 rotates the plurality of magnetic disks 12.

The housing 11 is provided with a support shaft 31 away from the magnetic disk 12. The support shaft 31 extends, for example, in the +Z direction from the bottom wall 25 of the housing 11. The HSA 14 is rotatably supported by the support shaft 31 about the support shaft 31.

The HSA 14 includes a carriage 35, a plurality of head gimbal assemblies (HGA) 36, and a flexible printed circuit board (FPC) 37. The carriage 35 includes an actuator block 41 and a plurality of arms 42.

The actuator block 41 is rotatably supported by the support shaft 31 through a bearing about the support shaft 31, for example. The plurality of arms 42 protrude substantially in parallel from the actuator block 41.

The plurality of arms 42 is disposed at intervals in the Z direction. Each of the plurality of arms 42 can enter a gap between two adjacent magnetic disks 12 among the plurality of magnetic disks 12.

The VCM 15 includes a voice coil attached to the carriage 35, a pair of yokes, and magnets provided on the yokes. The VCM 15 rotates the carriage 35 about the support shaft 31.

Each of the plurality of HGAs 36 includes a base plate 45, a load beam 46, a flexure 47, and a magnetic head 48. The base plate 45 is attached to the distal end of the arm 42. The load beam 46 is formed thinner than the base plate 45 and extends from the base plate 45.

The flexure 47 has an elongated belt shape. Note that the shape of the flexure 47 is not limited to this example. The flexure 47 is a kind of FPC including a metal plate (backing layer) made of stainless steel or the like, an insulating layer (base layer) formed on the metal plate, a conductive layer formed on the insulating layer and constituting a plurality of sets of wiring (wiring pattern), and an insulating layer (cover layer) covering the conductive layer.

The flexure 47 includes, at one end, a displaceable gimbal (elastic support)located on the load beam 46. The magnetic head 48 is mounted on a gimbal of the flexure 47. The magnetic head 48 records and reproduces information on and from the recording layer of the magnetic disk 12. In other words, the magnetic head 48 reads and writes information from and to the magnetic disk 12.

The VCM 15 rotates the carriage 35 to arrange the magnetic head 48 at a desired position on the magnetic disk 12. When the magnetic head 48 moves to the outermost periphery of the magnetic disk 12, the ramp load mechanism 16 holds the magnetic head 48 at an unload position away from the magnetic disk 12.

The FPC 37 is connected to the other end of the flexure 47. For example, a plurality of flexures 47 is connected to the FPC 37. Thus, the FPC 37 is electrically connected to the plurality of magnetic heads 48 through the wiring of the plurality of flexures 47.

The PCB 17 is, for example, a rigid substrate such as a glass epoxy substrate, and is a multilayer substrate or a build-up substrate. The PCB 17 is disposed outside the housing 11 and is attached to the bottom wall 25 of the base 21. The PCB 17 is attached to the bottom wall 25 with, for example, a plurality of screws.

The HDD 10 further includes, for example, an interface (I/F) connector 51, a controller 52, and a relay connector 53. The relay connector 53 is an example of a first connector. The I/F connector 51, the controller 52, and the relay connector 53 are mounted on the PCB 17. In addition, other component or components may be mounted on the PCB 17.

The I/F connector 51 is a connector conforming to an interface standard such as Serial ATA (SATA), and is connected to an I/F connector of a host computer. The controller 52 is, for example, a system-on-chip (SoC), and includes a read/write channel (RWC), a hard disk controller (HDC), and a processor.

The PCB 17 is electrically connected to various components disposed inside the housing 11 through the relay connector 53. For example, the PCB 17 is electrically connected to the spindle motor 13, the VCM 15, the FPC 37, the flexure 47, and the magnetic head 48.

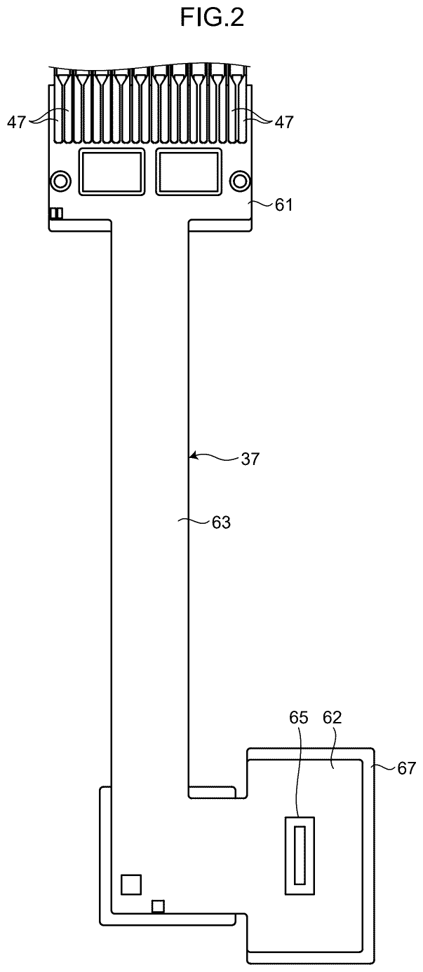

FIG. 2 is an exemplary plan view schematically illustrating the FPC 37 of the first embodiment. As illustrated in FIG. 2, the FPC 37 is detached from another component and has a substantially L-shaped belt shape in a natural state where no external force acts. Note that the shape of the FPC 37 is not limited to this example. The FPC 37 includes a first connection part 61, a second connection part 62, and an intermediate part 63.

The first connection part 61 is provided, for example, at one end portion of the FPC 37 in the direction in which the FPC 37 extends. The first connection part 61 is attached to the actuator block 41 by, for example, a screw. The first connection part 61 is connected to the plurality of flexures 47.

The second connection part 62 is provided, for example, at the other end portion of the FPC 37 in the direction in which the FPC 37 extends. The second connection part 62 is attached to the bottom wall 25 of the housing 11 by, for example, a screw.

The intermediate part 63 is provided between the first connection part 61 and the second connection part 62. The intermediate part 63 extends in a band shape and bends between the first connection part 61 and the second connection part 62 in accordance with rotation of the actuator block 41.

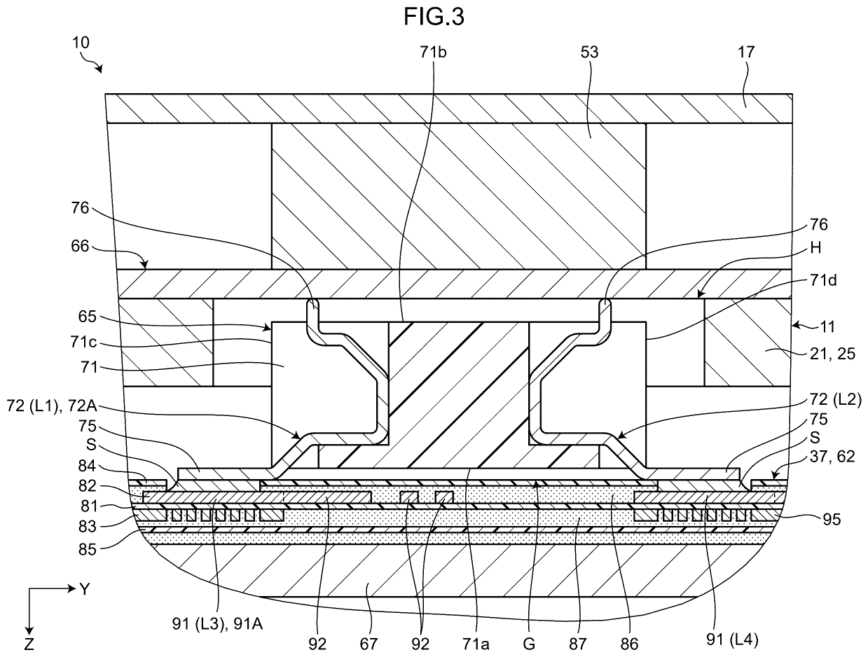

FIG. 3 is an exemplary cross-sectional view schematically illustrating part of the HDD 10 of the first embodiment. As illustrated in FIG. 3, the HSA 14 further includes a relay connector 65, a relay device 66, and a reinforcement plate 67. The relay connector 65 is an example of an electronic component and a second connector.

The relay connector 65 is mounted on the second connection part 62 of the FPC 37. The relay connector 65 is thus accommodated in the housing 11. The relay connector 65 is, for example, a compression connector. The relay connector 65 may be another connector such as a stacking connector. Further, the electronic component is not limited to the relay connector 65, and may be another electronic component. The relay connector 65 includes a case 71 and a plurality of pins 72. The case is an example of an insulating member.

The case 71 is made of an insulating material such as synthetic resin. The case 71 has, for example, a substantially rectangular parallelepiped shape extending in the X direction. The case 71 has a bottom face 71a, an upper face 71b, and two side faces 71c and 71d. It should be noted that the terms “upper” and “lower” in the present embodiment are terms for convenience based on FIG. 3, and do not limit directions, positions, and usage modes.

The bottom face 71a is formed to be substantially flat and faces the +Z direction. The bottom face 71a faces the second connection part 62 of the FPC 37. The upper face 71b is opposite the bottom face 71a and faces the-Z direction. The two side faces 71c and 71d are opposite to each other. The side face 71c faces the −Y direction. The side face 71d faces the +Y direction.

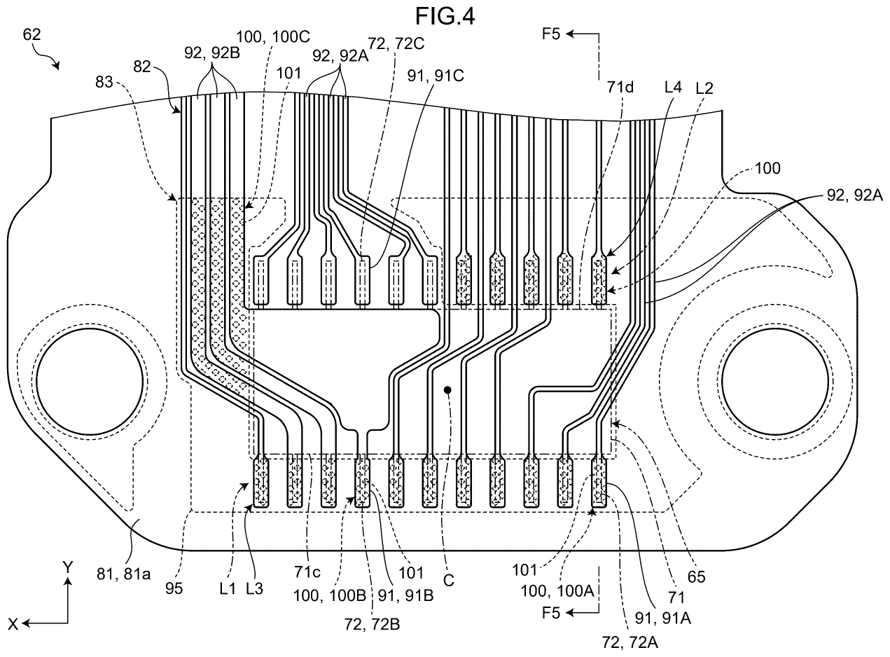

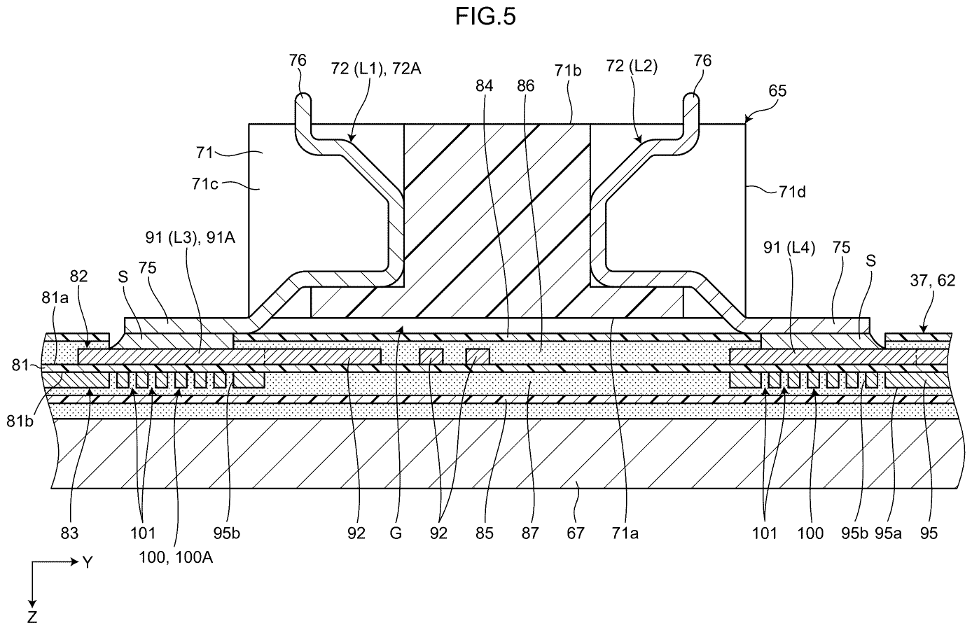

FIG. 4 is an exemplary plan view schematically illustrating the second connection part 62 of the FPC 37 of the first embodiment. FIG. 5 is an exemplary cross-sectional view schematically illustrating the second connection part 62 and the relay connector 65 of the first embodiment taken along line F5-F5 of FIG. 4.

As illustrated in FIG. 5, each of the plurality of pins 72 is held by the case 71, for example, by being fitted into a groove of the case 71. As illustrated in FIG. 4, the plurality of pins 72 is disposed in two rows L1 and L2. In the row L1 the plurality of pins 72 is disposed at substantially equal intervals in the X direction. The row L2 is spaced from the row L1 in the +Y direction. In the row L2 the plurality of pins 72 is disposed at substantially equal intervals in the X direction.

As illustrated in FIG. 5, each of the plurality of pins 72 has a joint 75 and a contact 76. The joint 75 is located at one end of the pin 72. The contact 76 is located at the other end of the pin 72.

In the row L1, each of the joints 75 of the plurality of pins 72 protrudes from the side face 71c of the case 71. In the row L2, the joints 75 of the plurality of pins 72 each protrude from the side face 71d of the case 71. Each of the contacts 76 of the plurality of pins 72 protrudes from the upper face 71b of the case 71.

The relay device 66 illustrated in FIG. 3 includes, for example, a PCB. The relay device 66 is attached to the bottom wall 25 so as to airtightly seal a through hole H formed in the bottom wall 25 of the base 21. In this manner, the relay device 66 is disposed in the housing 11.

The contacts 76 of the pins 72 contact the pad on the surface of the relay device 66. As a result, the relay device 66 and the relay connector 65 are electrically connected together. Further, a terminal of the relay connector 53 as a compression connector comes into contact with the relay device 66. Thereby, the relay connector 53 and the relay device 66 are electrically connected together. When the relay connector 53 is a stacking connector, the relay device 66 has a stacking connector connected to the relay connector 53.

The PCB 17 is electrically connected to the FPC 37 through the relay connector 53, the relay device 66, and the relay connector 65. As a result, the controller 52 is electrically connected to the magnetic head 48 through the PCB 17, the relay connector 53, the relay device 66, the relay connector 65, the FPC 37, and the flexure 47.

The reinforcement plate 67 is made of, for example, metal such as aluminum, or synthetic resin. Note that the reinforcement plate 67 is not limited to this example. The reinforcement plate 67 is attached to the second connection part 62 of the FPC 37. The second connection part 62 is located between the relay connector 65 and the reinforcement plate 67.

The reinforcement plate 67 has higher rigidity than the FPC 37. For this reason, the reinforcement plate 67 improves rigidity of the second connection part 62. At least part of the intermediate part 63 is not attached to the reinforcement plate 67 and can be bent.

As illustrated in FIG. 5, the FPC 37 includes a base layer 81, two conductive layers 82 and 83, two cover layers 84 and 85, and two adhesive layers 86 and 87. In FIG. 4, the cover layer 84 and the adhesive layer 86 are omitted for the sake of description.

The base layer 81 is an example of a first insulating layer. The conductive layer 82 is an example of a first conductive layer. The conductive layer 83 is an example of a second conductive layer. Cover layer 84 is an example of a third insulating layer. Cover layer 85 is an example of a second insulating layer. Adhesive layer 86 is an example of a second adhesive layer. Adhesive layer 87 is an example of a first adhesive layer.

The base layer 81 and the cover layers 84 and 85 are made of insulating synthetic resin such as polyimide (PI). The base layer 81 and the cover layers 84 and 85 may be made of another resin.

As illustrated in FIG. 5, the base layer 81 has a first face 81a and a second face 81b. The first face 81a faces substantially in the-Z direction. The first face 81a faces the relay connector 65. The second face 81b is opposite the first face 81a and faces substantially in the +Z direction. The second face 81b faces the reinforcement plate 67.

The conductive layers 82 and 83 are made of a conductive metal such as copper. Note that the material of the conductive layers 82 and 83 is not limited to this example. Each of the conductive layers 82 and 83 forms a wiring pattern of the FPC 37.

The conductive layer 82 is disposed on the first face 81a of the base layer 81. The conductive layer 82 includes a plurality of pads 91 and a plurality of sets of wiring 92. The pad 91 may be referred to as, for example, a land, an electrode, or a terminal.

The pad 91 is an electrode provided in the second connection part 62. As illustrated in FIG. 4, each of the plurality of pads 91 has, for example, a substantially rectangular shape. Note that the shape of the pad 91 is not limited to this example.

The conductive layer 82 further includes a plurality of other pads provided in the first connection part 61 and joined to the flexure 47. Each of the plurality of sets of wiring 92 connects at least two of the plurality of pads 91 provided in the second connection part 62 and the plurality of other pads provided in the first connection part 61. The conductive layer 82 may connect the pad 91 to another pad joined to the VCM 15, for example.

As with the plurality of pins 72, the plurality of pads 91 is disposed in two rows L3 and L4. In the row L3 the plurality of pads 91 are disposed at substantially equal intervals in the X direction. The row L4 is spaced from the row L3 in the +Y direction. In the row L4 the plurality of pads 91 are disposed at substantially equal intervals in the X direction.

As illustrated in FIG. 5, each of the plurality of pads 91 is electrically and mechanically joined to one corresponding joint 75 of the plurality of pins 72 by solder S. As a result, the relay connector 65 is mounted on the second connection part 62 of the FPC 37.

As illustrated in FIG. 4, the plurality of pads 91 includes, for example, pads 91A, 91B, and 91C. The plurality of pins 72 include pins 72A, 72B, and 72C. The pad 91A is an example of a first land. The pad 91B is an example of a second land. The pad 91C is an example of a third land. The pin 72A is an example of a first pin. The pin 72B is an example of a second pin. The pin 72C is an example of a third pin.

The pin 72A is located at the end of the row L1 of the plurality of pins 72. The pad 91A is located at the end of the row L3 of the plurality of pads 91. The pin 72A is joined to the pad 91A with solder S.

The pin 72B is one of the plurality of pins 72 included in the row L1. The pad 91B is one of the plurality of pads 91 included in the row L3. The pin 72B is joined to the pad 91B with the solder S.

The pin 72C is included in the row L2 of the plurality of pins 72. The pad 91C is included in the row L4 of the plurality of pads 91. The pin 72C is joined to the pad 91C by the solder S.

The pin 72C and the pad 91C are electrically connected to the magnetic head 48 through the wiring 92 and the flexure 47. The pin 72C and the pad 91C transmit a read signal or a write signal.

The read signal is an electric signal corresponding to information read from the magnetic disk 12 by the magnetic head 48. The write signal is an electric signal corresponding to information to be written by the magnetic head 48 to the magnetic disk 12. That is, the relay connector 65 receives a read signal at the pin 72C from the magnetic head 48 or outputs a write signal from the pin 72C to the magnetic head 48. Note that an electronic component such as an amplifier may be provided in the electric path between the pin 72C and the magnetic head 48.

For example, the pin 72A and the pad 91A are set to a ground potential or transmit an electric signal different from the write signal and the read signal. The electric signal different from the write signal and the read signal is, for example, an output signal of a touch sensing sensor, a control signal of a laser element of heat assisted magnetic recording (HAMR), a control signal of an oscillation element of microwave assisted magnetic recording (MAMR), or a control signal of a heater. The pin 72A and the pad 91A may transmit other electric signals.

The pin 72B and the pad 91B are set to the ground potential. A part of the wiring 92 connected to the pad 91B overlaps the case 71 of the relay connector 53 and forms a ground plane. The pins 72A, 72B, and 72C and the pads 91A, 91B, and 91C are not limited to the above examples.

The plurality of sets of wiring 92 includes, for example, a plurality of wires 92A and a plurality of wires 92B. The wires 92A are an example of second wiring. The wires 92B are an example of first wiring. Each of the wires 92A is thinner than each of the wires 92B. One of the plurality of wires 92A is connected to the pad 91A. One of the plurality of wires 92B is connected to the pad 91B.

The width of the wire 92A along the first face 81a is smaller than the width of the pad 91 along the first face 81a. The width of the wire 92B along the first face 81a is, for example, substantially the same as or partially thicker than the width of the pad 91 along the first face 81a. The widths of the wires 92A and 92B are not limited to this example.

As illustrated in FIG. 5, the conductive layer 83 is disposed on the second face 81b of the base layer 81. As illustrated in FIG. 4, the conductive layer 83 has a ground plane 95. The conductive layer 83 may have another pattern such as wiring.

The ground plane 95 is set to, for example, a ground potential. In the present embodiment, the ground plane 95 is spaced from a part, of the base layer 81, overlapping the case 71 of the relay connector 65. That is, the ground plane 95 of the present embodiment does not overlap the case 71. Note that the ground plane 95 may overlap the case 71.

In the present embodiment, the conductive layer 83 including the ground plane 95 is spaced from a part of the base layer 81 overlapping the pad 91C. In addition, the conductive layer 83 is spaced not only from the pad 91C but also from the part of the base layer 81 overlapping the pad 91 that transmits a read signal or a write signal. That is, the conductive layer 83 of the present embodiment does not overlap the pad 91 that transmits a read signal or a write signal. Note that the conductive layer 83 is not limited to this example.

As illustrated in FIG. 5, the cover layer 84 covers the first face 81a of the base layer 81 and the wiring 92 of the conductive layer 82. The cover layer 85 covers the second face 81b of the base layer 81 and the conductive layer 83. Thus, the base layer 81 and the conductive layers 82 and 83 are located between the two cover layers 84 and 85.

The adhesive layers 86 and 87 are, for example, an epoxy adhesive. The adhesive layers 86 and 87 may be an adhesive made of another resin such as an acrylic adhesive. The adhesive layer 86 bonds the cover layer 84 to the first face 81a and the wiring 92. The adhesive layer 87 bonds the cover layer 85 to the second face 81b and the conductive layer 83.

The cover layer 84 and the adhesive layer 86 are provided with a plurality of through holes. The cover layer 84 and the adhesive layer 86 expose the plurality of pads 91 to the outside of the FPC 37 through the through holes. The joints 75 of the pins 72 can be thus joined to the pads 91 using the solder S. The cover layer 85 is bonded to the reinforcement plate 67 with, for example, an adhesive.

The ground plane 95 of the conductive layer 83 includes a plurality of mesh-like parts 100. Each of the plurality of mesh-like parts 100 is part of the ground plane 95 having undergone mesh processing. That is, each of the plurality of mesh-like parts 100 is provided with a plurality of through holes 101. Each of the plurality of through holes 101 penetrates the ground plane 95 in the substantially Z direction. As illustrated in FIG. 4, each of the plurality of through holes 101 is a substantially rhombic hole. The through holes 101 may have another shape or mutually different shapes.

The plurality of mesh-like parts 100 include, for example, a plurality of mesh-like parts 100A, 100B, and 100C. The mesh-like part 100A is an example of a first part. The mesh-like part 100B is an example of a second part and a third part. The mesh-like part 100C is an example of a second part and a fourth part.

In the ground plane 95, the mesh-like part 100A is a part overlapping the pad 91A through the base layer 81. That is, the contour of the mesh-like part 100A substantially matches the contour of the pad 91A. Because of this, along the first face 81a, the mesh-like part 100A is larger in width than the wire 92A. The mesh-like part 100A is provided with the plurality of through holes 101. The plurality of through holes 101 of the mesh-like part 100A are an example of a plurality of first through holes.

In the ground plane 95, the mesh-like part 100B is a part overlapping the pad 91B through the base layer 81. The mesh-like part 100B is also a part of the ground plane 95 spaced from the mesh-like part 100A. The mesh-like part 100B is provided with the plurality of through holes 101. The plurality of through holes 101 of the mesh-like part 100B is an example of a plurality of second through holes and a plurality of third through holes.

The plurality of mesh-like parts 100 includes not only the mesh-like parts 100A and 100B but also the parts of the ground plane 95 overlapping the pads 91 through the base layer 81. In the present embodiment, among the plurality of pads 91, all the pads 91 overlapping the ground plane 95 through the base layer 81 overlap the through holes 101 through the base layer 81. At least part of the overlapping parts of the ground plane 95 with the pad 91 through the base layer 81 may not be the mesh-like parts 100.

The mesh-like part 100C is a part of the ground plane 95 overlapping the wires 92B through the base layer 81. The mesh-like part 100C is also a part of the ground plane 95 spaced from the mesh-like part 100A. The mesh-like part 100C is provided with the plurality of through holes 101. The plurality of through holes 101 of the mesh-like part 100C is an example of a plurality of second through holes and a plurality of fourth through holes.

As illustrated in FIG. 5, the adhesive layer 87 adheres to the second face 81b of the base layer 81 through the plurality of through holes 101. That is, the adhesive layer 87 adheres to the second face 81b of the base layer 81 through the plurality of through holes 101 of each of the mesh-like parts 100A, 100B, and 100C. In this case, the adhesive layer 87 is provided inside each of the plurality of through holes 101 and on the second face 81b of the base layer 81. In the present embodiment, the insides of the plurality of through holes 101 is filled with the adhesive layer 87.

The adhesive layer 87 also adheres to an outer face 95a of the ground plane 95 and an inner face 95b of the ground plane 95 that defines the through hole 101. However, the adhesive layer 87 made of resin such as epoxy is less likely to be chemically bonded to the ground plane 95 made of metal such as copper as compared with a case where the adhesive layer adheres to the resin. For this reason, the adhesive layer 87 weakly adheres to the outer face 95a and the inner face 95b of the ground plane 95.

On the other hand, the adhesive layer 87 is likely to be chemically bonded to the base layer 81 made of resin such as PI. Therefore, the adhesive layer 87 can be firmly adhered to the second face 81b of the base layer 81.

In addition, since the adhesive layer 87 adheres to the inner face 95b defining the plurality of through holes 101, a contact area between the adhesive layer 87 and the ground plane 95 is increased. In addition, since the adhesive layer 87 enters the plurality of through holes 101, an anchor effect is generated. Thus, the adhesive force between the adhesive layer 87 and the ground plane 95 is generally improved.

As described above, the adhesive layer 87 can relatively strongly adhere to the ground plane 95 and holds the ground plane 95 to the second face 81b of the base layer 81 through the through hole 101. As a result, the ground plane 95 is less likely to be exfoliated from the adhesive layer 87 and from the second face 81b of the base layer 81.

In the present embodiment, the plurality of mesh-like parts 100 of the ground plane 95 has undergone mesh processing to form the plurality of through holes 101. The rest of the ground plane 95 has not undergone the mesh processing. However, another part of the ground plane 95 may be subjected to mesh processing or the entire ground plane 95 may be subjected to mesh processing.

For example, when the relay connector 65 is mounted on the FPC 37 or connected to the relay device 66, mounting deviation may occur. Due to the mounting deviation, moment (torque) around a center C in FIG. 4 may be generated in the relay connector 65. The center C is, for example, a center axis of virtual rotation extending in the substantially Z direction. That is, a moment in a direction along the first face 81a of the base layer 81 may occur in the relay connector 65. In addition, a moment about the center C may be generated in the relay connector 65 due to the warpage of the FPC 37 and the relay connector 65.

Moment around the center C is generated in the relay connector 65 to apply a force around the center C from the pin 72 to the FPC 37 through the solder S, for example. The pins 72 located at the ends of the rows L1 and L2 are farther from the center C than the other pins 72. Therefore, a relatively large force acts from, for example, 72A of the plurality of pins 72 to the vicinity of the pad 91A of the FPC 37.

Due to the force around the center C, for example, torsional stress is generated at an adhesion portion between the second face 81b of the base layer 81 and the ground plane 95. When the adhesive force between the second face 81b and the ground plane 95 is weak, the ground plane 95 may peel off from the second face 81b due to the torsional stress. However, the adhesive layer 87 of the present embodiment firmly holds the ground plane 95 on the second face 81b.

Further, the adhesive layer 87 adheres to the second face 81b through the plurality of through holes 101. In this case, the adhesive layer 87 is provided inside each of the plurality of through holes 101 and on the second face 81b of the base layer 81. The adhesive layer 87 adheres to the inner face 95b of each of the plurality of through holes 101. For this reason, the adhesive layer 87 supports the inner face 95b of the ground plane 95 that defines the through hole 101, and restricts the movement of the ground plane 95 in the direction (X direction and Y direction) along the second face 81b with respect to the second face 81b. As described above, the FPC 37 according to the present embodiment can suppress peeling of the ground plane 95 from the second face 81b.

In addition, at the time of manufacturing the FPC 37, the cover layer 85 and the adhesive layer 87 may contain moisture. There is a possibility that the moisture expands by being heated in a furnace at the time of reflowing the solder S, for example, and peels the ground plane 95 from the second face 81b. However, the ground plane 95 of the present embodiment can promote the discharge of the moisture.

For example, the ground plane 95 does not overlap the case 71 of the relay connector 65 or the pad 91C. In addition, the ground plane 95 has a plurality of through holes 101. Therefore, moisture of the cover layer 85 and the adhesive layer 87 can be discharged from the FPC 37 through the through hole 101 and a portion not overlapping the case 71 and the pad 91C. Therefore, the FPC 37 of the present embodiment can suppress peeling of the ground plane 95 from the second face 81b due to moisture.

Hereinafter, part of a method of mounting the relay connector 65 on the FPC 37 will be exemplified. The method of mounting the relay connector 65 on the FPC 37 is not limited to the following method, and other methods may be used. First, solder paste (solder S) is supplied to the plurality of pads 91 by, for example, printing or coating.

Next, the relay connector 65 is mounted on the plurality of pads 91. Since the reinforcement plate 67 supports the relay connector 65 through the FPC 37, it is possible to suppress deformation of the FPC 37 at the time of mounting.

Next, the FPC 37 is heated in a reflow furnace, and the solder paste is melted. As a result, the joint 75 of the pin 72 is joined to the pad 91. At this time, the flux mixed with or separately supplied to the solder S may flow out of the solder S.

Next, the FPC 37 is cleaned by, for example, ultrasonic cleaning. For example, the FPC 37 is placed in a tank filled with a cleaning liquid. The cleaning liquid flows through a gap G between the FPC 37 and the case 71 of the relay connector 65, and can remove substances that may contaminate the HDD 10, such as flux.

The ground plane 95 overlaps at least one of the plurality of pads 91. Therefore, the ground plane 95 can suppress sinking of the pad 91 so that the case 71 approaches the FPC 37. Therefore, the gap G is kept relatively large, and the cleaning liquid can easily flow through the gap G.

For example, the cleaning liquid transmits the ultrasonic waves. The ultrasonic waves float the flux existing in the gap G from the FPC 37. Thereafter, the FPC 37 is taken out from the cleaning liquid. At this time, the cleaning liquid is discharged from the gap G together with the flux. Thus, the mounting of the relay connector 65 on the FPC 37 is completed.

In the HDD 10 according to the first embodiment described above, the magnetic head 48 is configured to read and write information from and to the magnetic disk 12. The FPC 37 is electrically connected to the magnetic head 48. The relay connector 65 is mounted on the FPC 37. The FPC 37 includes the base layer 81, the conductive layers 82 and 83, the cover layer 85, and the adhesive layer 87. The conductive layer 82 is disposed on the first face 81a of the base layer 81. The conductive layer 83 is disposed on the second face 81b of the base layer 81. The second face 81b is opposite the first face 81a. The cover layer 85 covers the second face 81b and the conductive layer 83. The adhesive layer 87 bonds the cover layer 85 to the second face 81b and the conductive layer 83. The conductive layer 82 includes the pad 91A. Of the conductive layer 83, the mesh-like part 100A overlapping the pad 91A through the base layer 81 is provided with the plurality of through holes 101. The adhesive layer 87 adheres to the second face 81b through the plurality of through holes 101. The relay connector 65 includes the pin 72A joined to the pad 91A.

Generally, the conductive layers 82 and 83 are made of a metal while the base layer 81, the cover layers 84 and 85, and the adhesive layers 86 and 87 are made of a resin. The metal and the resin are less likely to be chemically bonded together than adhesion of two resins, and they weakly adhere to each other. For example, moment may arise to cause the relay connector 65 to rotate (twist) with respect to the FPC 37 on the surface of the FPC 37, applying a force to the FPC 37 in the vicinity of the pad 91A in a direction along the FPC surface. The force also acts on the adhesive joint between the second face 81b of the base layer 81 and the conductive layer 83. In the present embodiment, however, the adhesive layer 87 adheres to the second face 81b through the plurality of through holes 101 formed in the conductive layer 83. Thereby, the adhesive layer 87 can more firmly hold the conductive layer 83 on the second face 81b than the adhesive layer 87 simply adhering to the second face 81b around the conductive layer 83. As a result, in the FPC 37 the conductive layer 83 becomes less likely or unlikely to be exfoliated from the second face 81b by the above force. In addition, during the manufacture of the FPC 37, it is made possible to release moisture contained in the cover layer 85 and the adhesive layer 87 to the outside through the through holes 101. As such, in the FPC 37 the conductive layer 83 can be less likely or unlikely to be exfoliated from the second face 81b by the moisture. Owing to the features as above, according to the HDD 10 of the present embodiment the FPC 37 can be improved in terms of reliability.

In the conductive layer 83, the mesh-like part 100B is spaced from the mesh-like part 100A and provided with the plurality of through holes 101. The adhesive layer 87 adheres to the second face 81b through the plurality of through holes 101. That is, the adhesive layer 87 can more firmly hold not only the vicinity of the pad 91A but also another part of the conductive layer 83 on the second face 81b. In this manner, in the FPC 37 the conductive layer 83 becomes less likely or unlikely to be exfoliated from the second face 81b.

The conductive layer 83 has the ground plane 95. The ground plane 95 includes the mesh-like part 100A. Thus, of the ground plane 95, the part overlapping the pad 91A through the base layer 81 is provided with the plurality of through holes 101. By adhering to the second face 81b through the plurality of through holes 101, the adhesive layer 87 can more firmly hold the ground plane 95 on the second face 81b. Consequently, the HDD 10 of the present embodiment allows the ground plane 95 to be provided in a wider region of the second face 81b, resulting in improving transmission characteristics such as the impedance of the conductive layer 82.

The conductive layer 82 includes the pad 91B. Of the ground plane 95, the mesh-like part 100B overlapping the pad 91B through the base layer 81 is provided with the plurality of through holes 101. The adhesive layer 87 adheres to the second face 81b through the plurality of through holes 101. The relay connector 65 includes the pin 72B joined to the pad 91B. That is, of one ground plane 95, the adhesive layer 87 can hold both the part close to the pad 91A and the part close to the pad 91B on the second face 81b through the through holes 101. The adhesive layer 87 holds the ground plane 95 on the second face 81b at a plurality of positions, thereby ensuring that the ground plane 95 can be avoided from being exfoliated from the second face 81b. In this manner, the HDD 10 according to the present embodiment allows the ground plane 95 to be provided in a wider region of the second face 81b.

The conductive layer 82 includes the wires 92B. The mesh-like part 100C, as the overlapping part of the ground plane 95 with the wires 92B through the base layer 81, is provided with a plurality of through holes 101. The adhesive layer 87 adheres to the second face 81b through the plurality of through holes 101. Specifically, of one ground plane 95, the adhesive layer 87 can hold both the part close to the pad 91A and the part close to the wires 92B on the second face 81b through the through holes 101. The adhesive layer 87 holds the ground plane 95 on the second face 81b at a plurality of positions, thereby ensuring that the ground plane 95 can be avoided from being exfoliated from the second face 81b. As such, the HDD 10 according to the present embodiment allows the ground plane 95 to be provided in a wider region of the second face 81b.

The housing 11 accommodates the magnetic disk 12, the magnetic head 48, the FPC 37, and the relay connector 65. The PCB 17 is located outside the housing 11. The relay connector 53 is mounted on the PCB 17. The relay device 66 is disposed in the housing 11 and is electrically connected to the relay connector 53. The relay connector 65 is electrically connected to the relay device 66. The PCB 17 is electrically connected to the FPC 37 through the relay connector 53, the relay device 66, and the relay connector 65. For example, at the time of connecting the relay connector 65 to the relay device 66, moment that can cause the relay connector 65 to rotate (twist) with respect to the FPC 37 on the surface of the FPC 37 may occur, which may result in applying a force to the FPC 37 in the vicinity of the pad 91A in a direction along the FPC surface. In the FPC 37 of the present embodiment, however, the conductive layer 83 is less likely or unlikely to be exfoliated from the second face 81b by such a force, as described above.

The relay connector 65 includes the case 71 and the plurality of pins 72 arranged in the row L1 and protruding from the case 71. The pin 72A is included in the plurality of pins 72 and located at the end of the row L1. For example, at the time when moment occurs and cause the relay connector 65 to rotate (twist) with respect to the FPC 37 on the surface of the FPC 37, the pin 72A at the end of the row may be more largely displaced than the pins at the center of the row. This may further cause a large force in the vicinity of the pad 91A of the FPC 37. In the FPC 37 of the present embodiment, however, the conductive layer 83 is less likely or unlikely to be exfoliated from the second face 81b by such a force, as described above.

The HDD 10 according to the present embodiment includes, for example, 10 or more magnetic disks 12. In this case, the number of HGAs 36 and the number of pins 72 of the relay connector 65 also increase. An increase in the number of functions of the HDD 10 will also increase the number of pins 72. A larger number of pins 72 may result in lengthening the distance between the center of the relay connector 65 and the pin 72A at the end, which may lead to displacing the pin 72A more largely. However, as described above, in the FPC 37 of the present embodiment, the conductive layer 83 is less likely or unlikely to be exfoliated from the second face 81b in the vicinity of the pin 72A and the pad 91A.

The conductive layer 82 includes the pad 91C. The conductive layer 83 is spaced from the part of the base layer 81 overlapping the pad 91C. The relay connector 65 includes the pin 72C joined to the pad 91C. The relay connector 65 is electrically connected to the magnetic head 48 to output a write signal, corresponding to information to be written by the magnetic head 48 to the magnetic disk 12, from the pin 72C to the magnetic head 48, or to receive, at the pin 72C, a read signal, corresponding to information read by the magnetic head 48 from the magnetic disk 12, from the magnetic head 48. The conductive layer 83 does not cover the pad 91C to which the write signal or the read signal is transmitted. As a result, according to the HDD 10 of the present embodiment, the conductive layer 83 becomes less likely or unlikely to affect the transmission of the write signal or the read signal. In addition, during the manufacture of the FPC 37, it is made possible to release moisture contained in the cover layer 85 and the adhesive layer 87 to the outside through the part of the base layer 81 uncovered with the conductive layer 83. As such, in the FPC 37 the conductive layer 83 can be less likely or unlikely to be exfoliated from the second face 81b by the moisture.

The relay connector 65 includes the case 71. The pin 72A protrudes from the case 71. The conductive layer 83 includes the ground plane 95 spaced from a part of the base layer 81, the part overlapping the case 71. That is, the ground plane 95 does not cover the case 71. As a result, during the manufacture of the FPC 37, it is possible to release moisture contained in the cover layer 85 and the adhesive layer 87 to the outside through the part of the base layer 81 uncovered by the ground plane 95. In this manner, in the FPC 37 the conductive layer 83 can be less likely or unlikely to be exfoliated from the second face 81b by the moisture.

### Second Embodiment

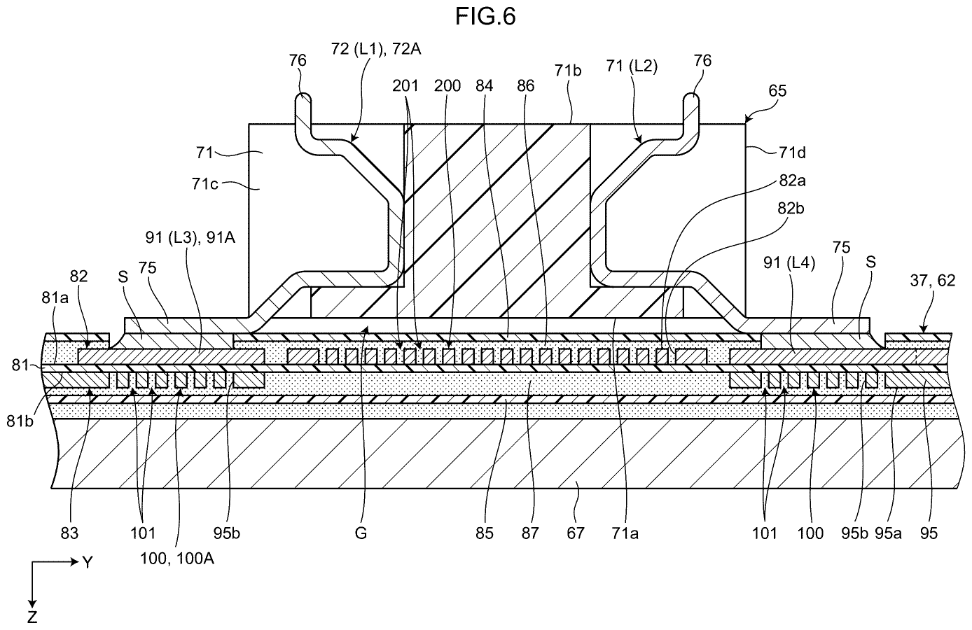

Hereinafter, the second embodiment will be described with reference to FIG. 6. In the following description of the embodiment, components having functions similar to those of the components already described are denoted by the same reference numerals as those of the components already described, and the description thereof may be omitted. In addition, the plurality of components denoted by the same reference numerals do not necessarily have all the functions and properties in common, and may have different functions and properties according to each embodiment.

FIG. 6 is an exemplary cross-sectional view schematically illustrating part of the HDD 10 according to the second embodiment. As illustrated in FIG. 6, the conductive layer 82 of the second embodiment includes at least one mesh-like part 200. The mesh-like part 200 is a part of the conductive layer 82 spaced from the plurality of pads 91. For example, the mesh-like part 200 is a ground plane. The mesh-like part 200 may be another part such as the wiring 92.

The mesh-like part 200 has undergone mesh processing. That is, the mesh-like part 200 is provided with a plurality of through holes 201. The plurality of through holes 201 is an example of a plurality of fifth through holes. Each of the plurality of through holes 201 penetrates the mesh-like part 200 in the substantially Z direction.

The adhesive layer 86 adheres to the first face 81a of the base layer 81 through the plurality of through holes 201. The adhesive layer 87 also adheres to an outer face 82a of the conductive layer 82 and an inner face 82b of the conductive layer 82 that defines the through holes 201.

As with the adhesive layer 87, the adhesive layer 86 weakly adheres to the outer face 82a and the inner face 82b of the conductive layer 82, and firmly adheres to the first face 81a of the base layer 81. In addition, since the adhesive layer 86 adheres to the plurality of inner faces 82b, a contact area between the adhesive layer 86 and the conductive layer 82 is provided large. In addition, since the adhesive layer 86 enters the plurality of through holes 201, an anchor effect is generated. Therefore, the adhesive force between the adhesive layer 86 and the conductive layer 82 is improved as a whole.

In the present embodiment, at least one mesh-like part 200 of the conductive layer 82 has undergone mesh processing to form the plurality of through holes 201, however, the rest thereof has not. However, another part of the conductive layer 82 may be meshed, or the entire conductive layer 82 may be meshed.

In the HDD 10 of the second embodiment described above, the FPC 37 includes the cover layer 84 and the adhesive layer 86. The cover layer 84 covers the first face 81a and a part of the conductive layer 82. The adhesive layer 86 bonds the cover layer 84 to the first face 81a and the conductive layer 82. Of the conductive layer 82, the mesh-like part 200 is spaced from the pad 91A and provided with the plurality of through holes 201. The adhesive layer 86 adheres to the first face 81a through the plurality of through holes 201. Because of this, the adhesive layer 86 can more firmly hold the conductive layer 82 on the first face 81a than the adhesive layer 86 simply adhering to the first face 81a around the conductive layer 82. As such, in the FPC 37, the conductive layer 82 becomes less likely or unlikely to be exfoliated from the first face 81a. In addition, during the manufacture of the FPC 37, it is made possible to release moisture contained in the base layer 81, the cover layer 85, and the adhesive layer 87 to the outside through the through holes 201. In this manner, in the FPC 37 the conductive layer 83 can be less likely or unlikely to be exfoliated from the first face 81a by the moisture. Owing to the features as above, the HDD 10 according to the present embodiment can allow the FPC 37 to be improved in reliability.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a magnetic disk;
a magnetic head configured to read and write information from and to the magnetic disk;
a flexible printed circuit board electrically connected to the magnetic head; and
an electronic component mounted on the flexible printed circuit board,
wherein the flexible printed circuit board includes
a first insulating layer,
a first conductive layer disposed on a first face of the first insulating layer,
a second conductive layer disposed on a second face of the first insulating layer, the second face being opposite the first face,
a second insulating layer covering the second face and the second conductive layer, and
a first adhesive layer bonding the second insulating layer to the second face and the second conductive layer,
the first conductive layer includes a first land,
the second conductive layer includes a first part with a plurality of first through holes, the first part overlapping the first land through the first insulating layer,
the first adhesive layer adheres to the second face through the plurality of first through holes, and
the electronic component includes a first pin joined to the first land.

2. The disk device according to claim 1, wherein
the second conductive layer includes a second part with a plurality of second through holes, the second part being spaced from the first part, and
the first adhesive layer adheres to the second face through the plurality of second through holes.

3. The disk device according to claim 1, wherein
the second conductive layer includes a ground plane, and
the ground plane includes the first part.

4. The disk device according to claim 3, wherein
the first conductive layer includes a second land,
the ground plane includes a third part with a plurality of third through holes, the third part overlapping the second land through the first insulating layer,
the first adhesive layer adheres to the second face through the plurality of third through holes, and
the electronic component includes a second pin joined to the second land.

5. The disk device according to claim 3, wherein
the first conductive layer includes first wiring,
the ground plane includes a fourth part with a plurality of fourth through holes, the fourth part overlapping the first wiring through the first insulating layer, and
the first adhesive layer adheres to the second face through the plurality of fourth through holes.

6. The disk device according to claim 1, wherein
the flexible printed circuit board includes
a third insulating layer covering the first face and a part of the first conductive layer, and
a second adhesive layer bonding the third insulating layer to the first face and the first conductive layer,
the first conductive layer includes a part with a plurality of fifth through holes, the part being spaced from the first land, and
the second adhesive layer adheres to the first face through the plurality of fifth through holes.

7. The disk device according to claim 1, further comprising:
a housing that accommodates the magnetic disk, the magnetic head, the flexible printed circuit board, and the electronic component;
a substrate located outside the housing;
a first connector mounted on the substrate; and
a relay device disposed in the housing and electrically connected to the first connector,
wherein the electronic component includes a second connector electrically connected to the relay device.

8. The disk device according to claim 1, wherein
the electronic component includes an insulating member, and a plurality of pins arranged in a row and protruding from the insulating member, and
the first pin is included in the plurality of pins and is located at an end of the row.

9. The disk device according to claim 1, wherein
the first conductive layer includes a third land,
the second conductive layer is spaced from a part of the first insulating layer, the part overlapping the third land,
the electronic component includes a third pin joined to the third land,
the electronic component is electrically connected to the magnetic head, to output a write signal from the third pin to the magnetic head or to receive, at the third pin, a read signal from the magnetic head, the write signal corresponding to information to be written by the magnetic head to the magnetic disk, the read signal corresponding to information read by the magnetic head from the magnetic disk.

10. The disk device according to claim 1, wherein
the electronic component includes an insulating member,
the first pin protrudes from the insulating member, and
the second conductive layer includes a ground plane spaced from a part of the first insulating layer, the part overlapping the insulating member.

11. The disk device according to claim 1, wherein
the first conductive layer includes second wiring connected to the first land, and
along the first face, the first part is larger in width than the second wiring.
